(19) United States
(12) Patent Application Publication
(10) Pub. No.: US 2019/0066905 A1
(43) Pub. Date: Feb. 28, 2019

(54) COIL COMPONENT AND METHOD OF MANUFACTURING THE SAME

(71) Applicant: SAMSUNG ELECTRO-MECHANICS CO., LTD., Suwon-si (KR)

(72) Inventors: Seung Hee HONG, Suwon-si (KR); Seung Jae SONG, Suwon-si (KR); Min Ki JUNG, Suwon-si (KR); Sang Jong LEE, Suwon-si (KR)

(21) Appl. No.: 16/004,809

(22) Filed: Jun. 11, 2018

(30) Foreign Application Priority Data
Aug. 23, 2017 (KR) 10-2017-0106747

(51) Int. Cl. H01F 27/28; H01F 27/29; H01F 27/32; H01F 41/04; H01F 41/12

(52) U.S. Cl. CPC H01F 27/2804; H01F 27/29; H01F 2027/2809; H01F 41/043; H01F 41/122; H01F 27/323

(57) ABSTRACT

A coil component may include a body with a plurality of coils with insulating layers interposed therebetween. The plurality of coils may include first and second coils having a different number of turns. The first and second coils may be connected to each other in parallel.

### CROSS-REFERENCE TO RELATED APPLICATION(S)

This application claims benefit of priority to Korean Patent Application No. 10-2017-0106747 filed on Aug. 23, 2017 in the Korean Intellectual Property Office, the disclosure of which is incorporated herein by reference in its entirety.

### BACKGROUND

### 1. Field

The present disclosure relates to a coil component and a method of manufacturing the same.

### 2. Description of Related Art

Recent smartphones use signals in a wide frequency band. A coil component has been mainly used in an impedance matching circuit in a radio frequency (RF) system for transmitting/receiving a high-frequency signal, and the use of such a high-frequency coil component has gradually increased.

Coil components should be usable at a high frequency of 100 MHz or more due to a self resonance frequency (SRF) in the high frequency band and low specific resistance based on miniaturization. In order to decrease loss at the device frequency, the coil component has needed to have a high quality (Q) factor.

It may be difficult to implement coil components with significantly low inductance. In general, inductance of an inductor may be adjusted by increasing or decreasing turns of a coil. However, this approach is not suitable to implement inductors with significantly low inductance, because the small number of turns makes it difficult to satisfy the desired inductance.

Therefore, research into a novel structure for implementing an inductor having significantly low inductance has been required.

### SUMMARY

An aspect of the present disclosure may provide a coil component capable of implementing significantly low inductance to be desired by combining different coil structures in parallel with each other in a single inductor, and a method of manufacturing the same.

According to an aspect of the present disclosure, a coil component may include a body including a plurality of coils. The plurality of coils may include a first coil with a first number of turns and a second coil with a second number of turns. The first number of turns of the first coil may be different from the second number of coils of the second coil. The first and second coils may be connected to each other in parallel. A method of manufacturing the coil component is also provided.

According to another aspect of the present disclosure, an overall inductance of the plurality of coils can be within a range between a first inductance of the first coil and a second inductance of the second coil.

According to another aspect of the present disclosure, a method of manufacturing a coil component may include preparing a plurality of first insulating sheets on which first coil patterns of a first coil are respectively formed and preparing a plurality of second insulating sheets on which second coil patterns of a second coil are respectively formed. The first and second insulating sheets may be simultaneously stacked to form a body including the first and second coils. The number of turns of the first and second coils may be are different from each other, and the first and second coils may be connected to each other in parallel.

### BRIEF DESCRIPTION OF DRAWINGS

The above and other aspects, features, and advantages of the present disclosure will be more clearly understood from the following detailed description taken in conjunction with the accompanying drawings, in which:

FIG. 1 is a schematic perspective view of a coil component including a coil according to a first exemplary embodiment in the present disclosure;

FIG. 2 is a schematic exploded view of a body of the coil component according to the first exemplary embodiment in the present disclosure;

FIG. 3 is a plan view of the coil of the coil component of FIG. 1;

FIG. 4 is a cross-sectional view of the coil of the coil component of FIG. 1 in a length-thickness (L-T) direction;

FIG. 5 is a schematic perspective view of a coil component according to a second exemplary embodiment in the present disclosure;

FIG. 6 is a schematic exploded view of a body of the coil component according to the second exemplary embodiment in the present disclosure;

FIG. 7 is a plan view of a coil of the coil component of FIG. 5;

FIG. 8 is a schematic perspective view of a coil component according to a third exemplary embodiment in the present disclosure;

FIG. 9 is a schematic exploded view of a body of the coil component according to the third exemplary embodiment in the present disclosure;

FIG. 10 is a plan view of a coil of the coil component of FIG. 8; and

FIG. 11 is a process flow chart illustrating a method of manufacturing a coil component according to an exemplary embodiment in the present disclosure.

### DETAILED DESCRIPTION

Hereinafter, exemplary embodiments of the present disclosure will be described in detail with reference to the accompanying drawings.

Coil components according to exemplary embodiments in the present disclosure will be described, but the present disclosure is not necessarily limited thereto.

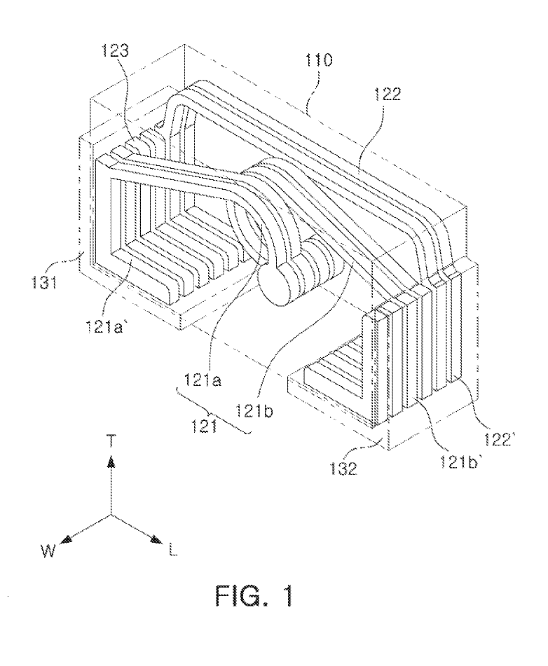

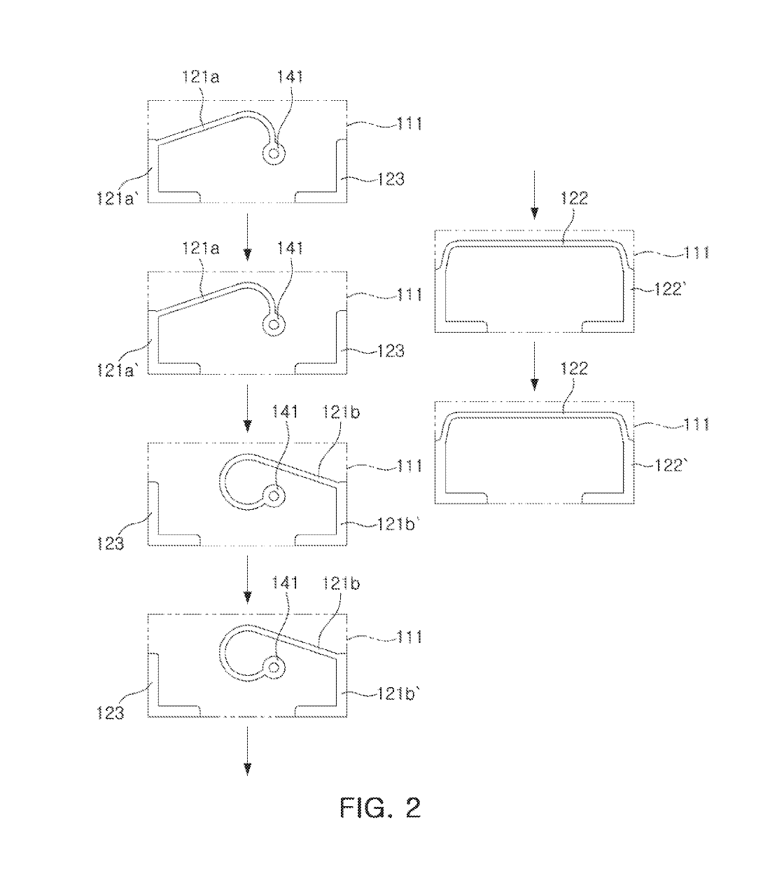

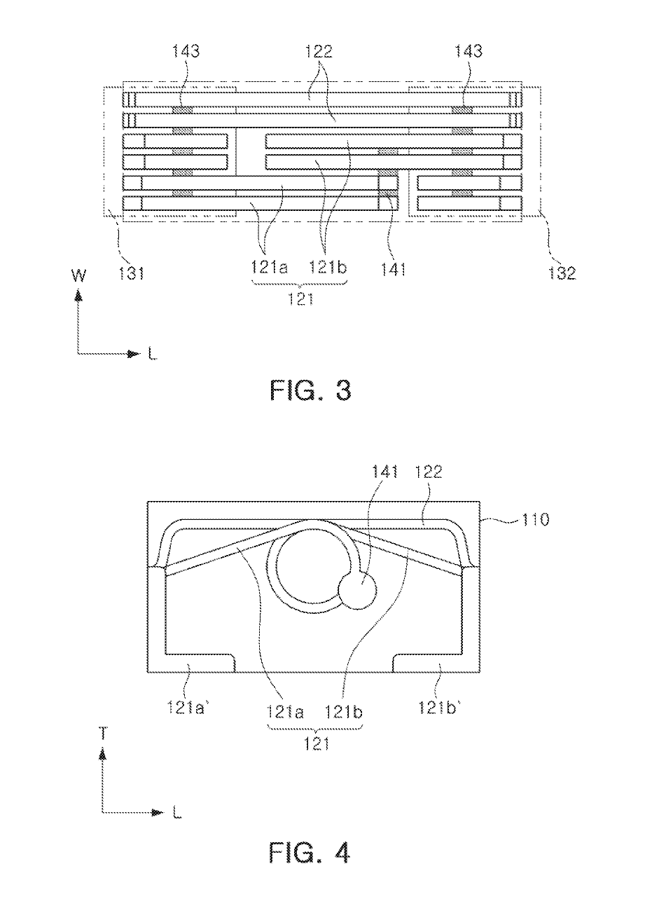

FIG. 1 is a schematic perspective view of a coil component including a coil according to a first exemplary embodiment in the present disclosure. FIG. 2 is a schematic exploded view of a body of the coil component according to the first exemplary embodiment in the present disclosure. FIG. 3 is a plan view of a coil of the coil component of FIG. 1. FIG. 4 is a cross-sectional view of the coil of the coil component of FIG. 1 in a length-thickness (L-T) direction.

Referring to FIGS. 1 through 4, the coil component according to the first exemplary embodiment in the present disclosure may include a body 110 including a plurality of coils with insulating layers 111 interposed therebetween. The plurality of coils may include first and second coils 121 and 122 having a different number of turns. The first and second coils 121 and 122 may be connected to each other in parallel.

The body 110 may be formed by stacking a plurality of insulating layers. The plurality of insulating layers forming the body 110 may be in a sintered state, and adjacent insulating layers may be integrated so that boundaries therebetween are not readily apparent without using a scanning electron microscope (SEM).

The body 110 may have a hexahedral shape. Directions L, W, and T illustrated in FIG. 1 refer to a length direction, a width direction, and a thickness direction, respectively.

The body 110 may be formed of ferrite, which may be, for example, Mn—Zn based ferrite, Ni—Zn based ferrite, Ni—Zn—Cu based ferrite, Mn—Mg based ferrite, Ba based ferrite, Li based ferrite, or the like, but is not limited thereto.

The first and second coils 121 and 122 may be formed by printing a conductive paste containing a conductive metal on the plurality of insulation layers 111 forming the body 110 at a predetermined thickness.

The conductive metal forming the first and second coils 121 and 122 is not particularly limited as long as it has excellent electric conductivity. The conductive metal may be, for example, silver (Ag), palladium (Pd), aluminum (Al), nickel (Ni), titanium (Ti), gold (Au), copper (Cu), platinum (Pt), or the like, either alone, or in a mixture thereof.

The first coil 121 may be formed of first and second coil patterns 121a and 121b connected to each other by a first via 141 in the body 110 and exposed to respective end surfaces of the body 110.

The first and second coil patterns 121a and 121b may have different polarities from each other.

A first via 141 may be formed at a predetermined position on each of the insulating layers on which the first coil pattern 121a is formed and each of the insulating layers on which the second coil pattern 121b is formed. The first and second coil patterns 121a and 121b formed on the insulating layers, respectively, may be electrically connected to each other through the first via 141, thereby forming a single coil.

The first via 141 may be formed by forming a through hole using a mechanical drill, a laser drill, or the like, and then filling a conductive material in the through hole by a plating method.

The first via 141 may contain a conductive material such as copper (Cu), aluminum (Al), silver (Ag), tin (Sn), gold (Au), nickel (Ni), lead (Pb), an alloy thereof, or the like.

The plurality of insulating layers 111 on which the first coil pattern 121a is formed and the plurality of insulating layers 111 on which the second coil pattern 121b is formed may be stacked in the width (W) or length (L) direction of the body. That is, the first and second coil patterns 121a and 121b may be disposed in a direction perpendicular to aboard mounting surface of the body 110, which can be the lower surface of the body 110 in the thickness (T) direction.

The first coil pattern 121a may include a first lead portion 121a′ exposed to one surface of the body 110 in the length direction. The second coil pattern 121b may include a second lead portion 121b′ exposed to the opposing surface of the body 110 in the length direction.

The second coil 122 may include lead portions 122′ respectively exposed to both opposing surfaces of the body 110 in the length direction.

According to the first exemplary embodiment, the plurality of coils may include first and second coils 121 and 122 having a different numbers of turns.

That is, the first coil 121 may have a different number of turns from the second coil 122. The first and second coils 121 and 122 may also be connected to each other in parallel.

Generally, it may be difficult to implement a coil component with significantly low inductance. Inductance of an inductor may conventionally be adjusted by increasing or decreasing the number of turns of the coil, but this is not suitable to achieve inductors with significantly low inductance. The unit of turns is excessively small, so it is difficult to satisfy the desired inductance by increasing or decreasing the number of turns.

Due to the structure of an inductor, the number of turns of the coil must be a number such as 1.5 turns, 2.5 turns, 3.5 turns, or the like, and the specific inductance desired may not be achievable simply by adding or removing a whole turn.

For example, it may not be possible to achieve an inductance between the inductance of an inductor where a plurality of coils with 0.5 turns are stacked and the inductance of an inductor where a plurality of coils with 1.5 turns are stacked.

The maximum inductance for the inductor where the plurality of coils with 0.5 turns are stacked may be about 0.28 nH, and the minimum inductance for the inductor where the plurality of coils with 1.5 turns are stacked may be about 0.37 nH.

Therefore the inductor may be unable to have an inductance between 0.28 nH and 0.37 nH.

Furthermore, process deviations may enlarge this range of inductances that may be unobtainable.

According to the related art, there was an attempt to obtain inductance by adjusting the line width of the coil to change the area of the core and thereby obtain the inductance described above. However, this approach was difficult to implement.

According to the first exemplary embodiment in the present disclosure, in an inductor having a significantly low inductance may be implemented by having a composite structure where the first and second coils 121 and 122 have a different number of turns and are connected to each other in parallel.

According to the present disclosure, different coil structures may be combined in parallel with each other in a single inductor, such a specific, significantly low inductance may be implemented.

Referring to FIGS. 1 through 4, in the first exemplary embodiment, the first coil 121 may have 1.5 turns and the second coil 122 connected in parallel to the first coil 121 may have 0.5 turns. However, the first and second coils 121 and 122 are not necessarily limited thereto. A significantly low inductance may be implemented by combining coils having different structures with each other using various combinations.

The first coil 121 may have a coil structure with 1.5 turns by connecting the first coil patterns 121a respectively disposed on two insulating layers and the second coil patterns 121b on two insulating layers to each other through the first via 141. In the second coil 122, coils with 0.5 turns respectively disposed on two insulating layers may be disposed in parallel with each other.

In relation to the exemplary inductor described above with a potential inductance between 0.28 nH, the maximum inductance capable of being implemented by the inductor in which the plurality of coils with 0.5 turns are stacked, and 0.37 nH, the minimum inductance capable of being implemented by the inductor in which the plurality of coils with 1.5 turns are stacked, an inductance value within the range may be implemented by the above-mentioned structure.

That is, an inductance with a range that may be hard or impossible to implement according to the related art may be easily implemented by adjusting the numbers of stacked first and second coils with different numbers of turns according to the present disclosure.

For example, according to the first exemplary embodiment, an inductance of 0.312 nH in a section between 0.28 nH and 0.37 nH, which is hard or impossible to implement according to the related art, maybe implemented. Furthermore, if the line width of the coil is also changed according to the method described below, an inductance of at least 0.286 nH to at most 0.335 nH may be implemented.

As described above, it may be appreciated that it can be easier to implement the desired inductance in the composite structure according to the first exemplary embodiment as compared to a structure according to the related art.

The difference between the number of turns of the first coil 121 and the number of turns of the second coil 122 may be “A” turns (where “A” is a natural number).

The related art attempted to obtain various inductances, but the number of turns of the coil could only be adjusted to a decimal smaller than 1.0 turn such as 0.75 turns, 0.5 turns, or the like.

However, since the coil component according to the first exemplary embodiment has a structure in which the external electrodes are fixed to both sides of the body and the coil in the body is connected to the external electrodes disposed on both sides of the body, the difference between the number of turns of the first coil 121 and the number of turns of the second coil 122 may be the “A” number of turns (where “A” is a natural number).

That is, according to the first exemplary embodiment in the present disclosure, when the number of turns of the first coil 121 is 1.5 turns and the number of turns of the second coil 122 is 0.5 turns, a difference between turns may be 1 turn, which is a natural number.

As another example, when the number of turns of the first coil 121 is 2.5 turns and the number of turns of the second coil 122 is 0.5 turns, the difference between turns may be 2 turns, which is also a natural number.

The related art also attempted to vary the inductance by using a structure in which coils with various patterns are connected in series to each other by a via to implement the desired inductance. However, the first exemplary embodiment in the present disclosure provides a composite structure in which coil structures with different numbers of turns are connected to each other in parallel, such that the desired inductance may be implemented in the inductor with a significantly low inductance.

When the number of turns of the first coil 121 is [0.5+(M-1)] turns (where “M” is a natural number), the number of turns of the second coil 122 is [0.5+N] turns (where “N” is a natural number), and “M” and “N” may be the same as each other.

That is, when the number of turns of the first coil 121 is [0.5+(M-1)] turns and the number of turns of the second coil 122 is [0.5+N] turns, if M and N are equal to each other, the a difference between turns of the first and second coils 121 and 122 is 1.0 turn. For example, the first and second coils 121 and 122 may respectively have 0.5 turns and 1.5 turns, 1.5 turns and 2.5 turns, or the like, but the first and second coils 121 and 122 are not limited thereto.

When the number of turns of the first coil 121 is [0.5+(M-1)] turns and the number of turns of the second coil 122 is [0.5+N] turns, M and N may be different from each other.

That is, the difference between the number of turns of the first and second coils 121 and 122 may vary. For example, the first and second coils 121 and 122 may respectively have 0.5 turns and 2.5 turns, 0.5 turns and 3.5 turns, 1.5 turns and 3.5 turns, or the like, but the first and second coils 121 and 122 are not limited thereto.

The first and second coils 121 and 122 may have different numbers of turns from each other and be connected to each other in parallel, such that a density of a current flowing in each of the coils may be decreased, and thus resistance loss may be significantly decreased.

Unlike the structure according to the related art, in the structure according to the present disclosure a single coil pattern may be connected to another coil pattern adjacent thereto, an influence of the via on an insulation distance may be decreased, and the manufacturing process may be simplified, thereby decreasing variation in product characteristics.

The first and second coils 121 and 122 may have a shape such as a polygon, a circle, an oval, a track, or the like.

External electrodes 131 and 132 may be disposed on respective end portions of the body 110. The first coil 121 may have lead portions 121a′ and 121b′ exposes to respective end portions of the body 110. The second coil 122 may have lead portions 122′ exposed to respective end portions of the body 110. The first and second coils 121 and 122 may be connected to each other by the external electrodes 131 and 132.

The first and second coils 121 and 122 may also be connected to each other by a third via 143 connecting lead portions 121a′, 121b′, and 122′.

More specifically, the first coil 121 may be formed of the first coil pattern 121a may have a first lead portion 121a′ exposed to one end portion of the body 110 in the length direction. The second coil pattern 121b may have a second lead portion 121b′ exposed to the opposing end portion of the body 110 in the length direction. The second coil 122 may have lead portions 122′ exposed to respective end portions of the body 110 in the length direction.

The lead portions 121a′, 121b′, and 122′ may be connected to each other by a third via 143. The first and second coils 121 and 122 may otherwise be insulated from each other in the body 110.

As described above, since the first and second coils 121 and 122 are insulated from each other in the body 110, the first and second coils 121 and 122 may be connected to each other in parallel.

The lead portions 121a′, 121b′, and 122′ may be exposed to a lower surface of the body 110 corresponding to the board mounting surface thereof. That is, the lead portions 121a′, 121b′, and 122′ may have an “L” shape in a cross section of the body 110 in a length-thickness direction.

According to the exemplary embodiment in the present disclosure, the body 110 may further include a dummy lead portion 123 disposed on the plurality of insulating layers and exposed to the outside.

The dummy lead portions 123 may be included in the body 110 by forming patterns on the plurality of insulating layers in the same shapes as those of the lead portions 121a′, 121b′, and 122′, respectively.

The dummy lead portion 123 may be connected to the first and second coils 121 and 122 through the third via 143, and the first and second coils 121 and 122 may be connected in parallel thereto, respectively.

That is, the body 110 according to the exemplary embodiment in the present disclosure may be implemented by stacking the plurality of insulating layers on which the first and second coils 121 and 122 are formed, respectively, and the plurality of insulating layers on which the dummy lead portion 123 is formed to be adjacent to each other.

Including dummy lead portions 123 provide a larger number of metallic bonds with the external electrodes 131 and 132 on the end surfaces of the body 110 in the length direction and the lower surface thereof. As such, adhesive strength between the first and second coils 121 and 122 and the external electrodes 131 and 132, and adhesive strength between the coil component and a printed circuit board, may be improved.

The first external electrode 131 may be on a first end surface of the body 110 in the length direction and on the lower surface thereof. The first external electrode 131 may be connected to the first lead portion 121a′ of the first coil and to the lead portion 122′ of the second coil. The second external electrode 132 may be on a second end surface of the body 110, opposing the first end surface in the length direction, and on the lower surface thereof. The second external electrode 132 may be connected to the second lead portion 121b′ of the first coil and to the lead portion 122′ of the second coil.

The first and second external electrodes 131 and 132 may be formed on the lower surface of the body 110 and surfaces thereof perpendicular to a stacking surface of the body 110, particularly, the end surfaces of the body 110 opposing each other in the length direction, to be connected to the lead portions 121a′, 121b′, and 122′ of the first and second coils 121 and 122.

The metal forming the first and second external electrodes 131 and 132 is not particularly limited and may be plated. For example, the first and second external electrodes 131 and 132 may be formed of one of nickel (Ni), tin (Sn), and the like, or a mixture thereof.

The first and second coils 121 and 122 may be formed of a plurality of coil patterns. Among the plurality of coil patterns, coil patterns having the same shape as each other may be disposed in parallel with each other.

As illustrated in FIGS. 1 through 4, the coil component may have a structure in which the first coil 121 is formed of first coil patterns 121a with the same shape and respectively disposed on two insulating layers and second coil patterns 121b with the same shape and respectively disposed on two insulating layers. The second coils 122 may have the same shape and may be respectively disposed on two insulating layers. However, the coil component structure is not necessarily limited thereto.

According to the first exemplary embodiment, the first and second coils 121 and 122 may have different line widths from each other.

In addition, the first and second coil patterns 121a and 121b of the first coil 121 may have different line widths from each other.

According to the present disclosure, it may be easy to implement an inductance valve within a range of inductances that are hard to implement by adjusting the line widths of the first and second coils 121 and 122 to be different from each other.

The inductance may be finely adjusted by adjusting the turns of the first and second coils 121 and 122 to be different from each other, by disposing the first and second coils 121 and 122 in parallel with each other, and by adjusting the line widths of the first and second coils 121 and 122 to be different from each other.

As described above, the range of inductance values that can be implemented can be enlarged by adjusting the turns of the first and second coils 121 and 122 to be different from each other. Adjusting the line widths thereof to be different from each other may further enlarge the range of the inductances that can be implemented.

The first and second coils 121 and 122 may have different thicknesses from each other, and the first and second coil patterns 121a and 121b of the first coil 121 may also have different thicknesses from each other.

According to the present disclosure, it may be easy to implement an inductance valve within a range of inductances that are hard to implement by adjusting the thicknesses of the first and second coils 121 and 122 to be different from each other.

That is, the inductance may be finely adjusted by adjusting turns of the first and second coils 121 and 122 to be different from each other, by dispose the first and second coils 121 and 122 in parallel with each other, and by adjusting the thicknesses of the first and second coils 121 and 122 to be different from each other.

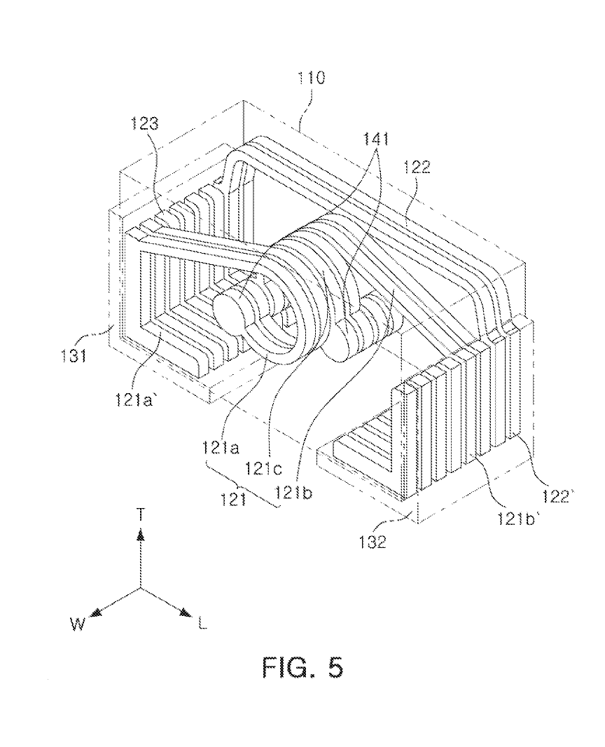

FIG. 5 is a schematic perspective view of a coil component according to a second exemplary embodiment in the present disclosure.

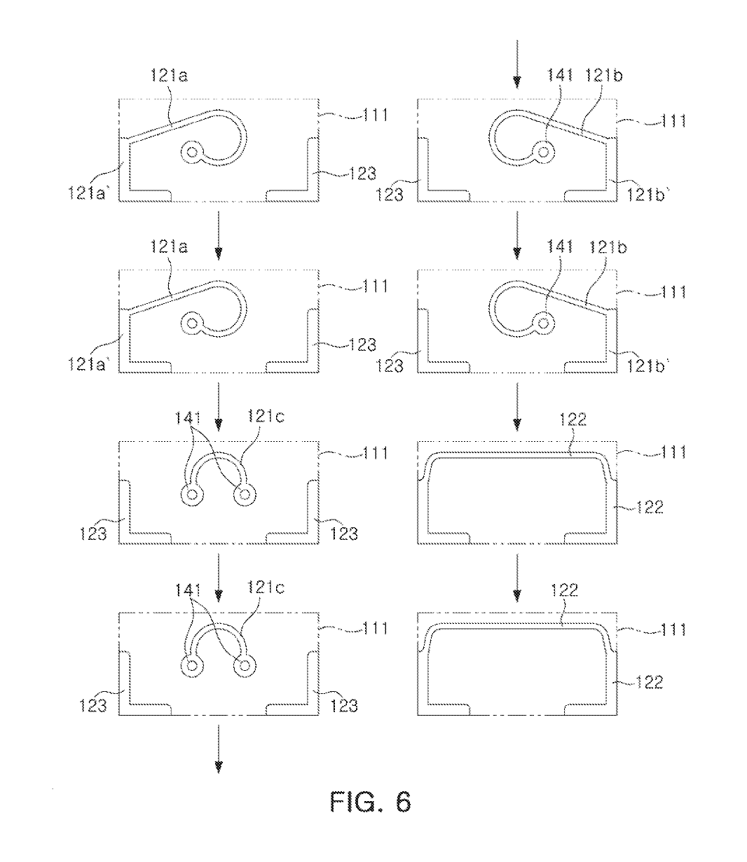

FIG. 6 is a schematic exploded view of a body of the coil component according to the second exemplary embodiment in the present disclosure.

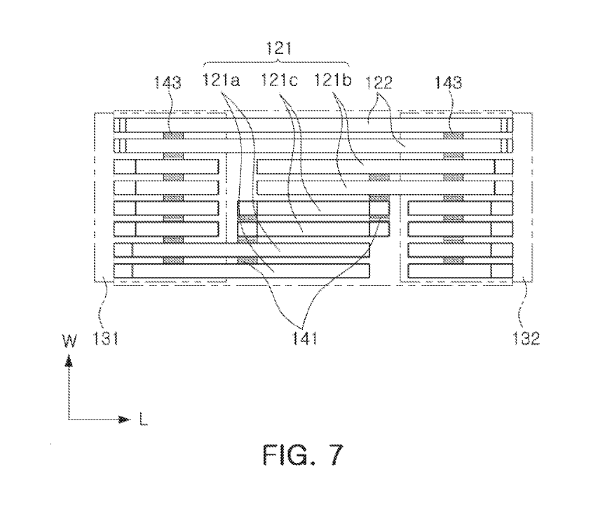

FIG. 7 is a plan view of a coil of the coil component of FIG. 5.

Referring to FIGS. 5 through 7, the coil component according to the second exemplary embodiment in the present disclosure may have a structure similar to that of the coil component according to the first exemplary embodiment, but may differ in that a connection pattern 121c is further included in the coil component.

More specifically, according to the second exemplary embodiment in the present disclosure, a first coil 121 may include first and second coil patterns 121a and 121b connected to each other by a first via 141 in a body 110 and exposed to respective end surfaces of the body 110, and a connection pattern 121c disposed between the first and second coil patterns 121a and 121b.

Because the first coil 121 includes the first and second coil patterns 121a and 121b and the connection pattern 121c between the first and second coil patterns 121a and 121b, the first coil 121 may have a coil structure with 2.5 turns.

According to the second exemplary embodiment, the number of turns of the first coil 121 may be 2.5 turns, and the number of turns of a second coil 122 may be 0.5 turns as in the first exemplary embodiment, such that a difference between turns of the first and second coils may be 2.0 turns.

The coil component according to the second exemplary embodiment in the present disclosure may have an inductance between an inductance of the first coil 121 with 2.5 turns and an inductance of the second coil 122 with 0.5 turns.

More specifically, the coil component according to the second exemplary embodiment in the present disclosure may have an inductance within a range between a minimum inductance value of the first coil with 2.5 turns and a maximum inductance value of the second coil 122 with 0.5 turns.

As in the first exemplary embodiment in the present disclosure, external electrodes 131 and 132 may be disposed on respective end portions of the body 110. The first coil 121 may have lead portions 121a′ and 121b′ exposed to one end portion of the body 110, and second coil 121 may have lead portions 122′ exposed to the opposing end portions of the body 110. The first and second coils 121 and 122 may be connected to each other by the external electrodes 131 and 132.

The first and second coils 121 and 122 may also be connected to each other by a third via 143 connecting the lead portions 121a′, 121b′, and 122′.

More specifically, the first coil 121 may be formed of the first coil pattern 121a having a first lead portion 121a′ and exposed to one end portion of the body 110 in a length direction and the second coil pattern 121b having a second lead portion 121b′ exposed to the opposing end portion of the body 110 in the length direction. The second coil 122 may have lead portion 122′ exposed to respective end portions of the body 110 in the length direction.

The lead portions 121a′, 121b′, and 122′ may be connected to each other by the third via 143. The first and second coils 121 and 122 may otherwise be insulated from each other in the body 110.

As described above, since the first and second coils 121 and 122 are insulated from each other in the body 110, the first and second coils 121 and 122 may be connected to each other in parallel.

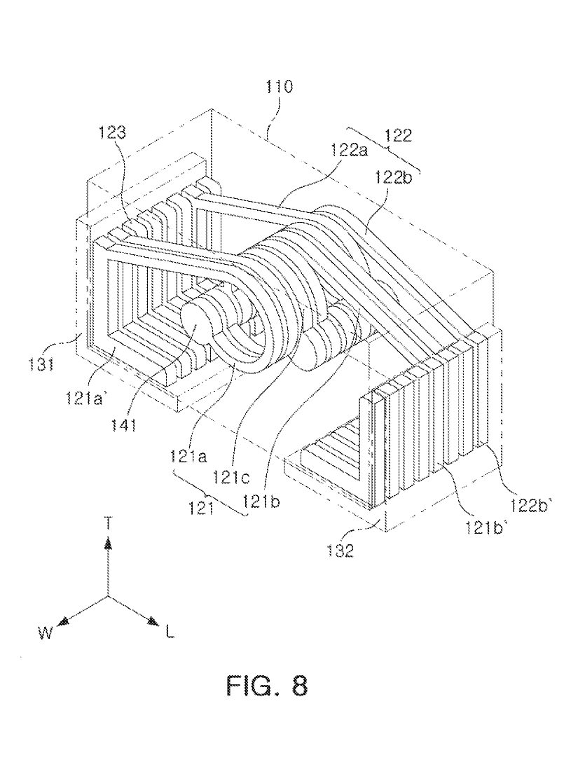

FIG. 8 is a schematic perspective view of a coil component according to a third exemplary embodiment in the present disclosure.

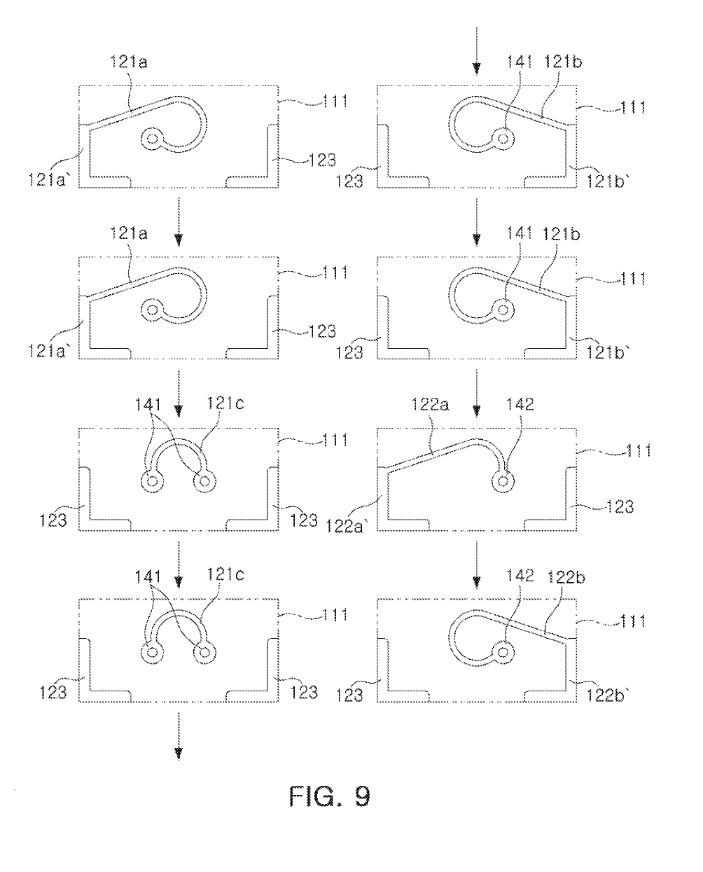

FIG. 9 is a schematic exploded view of a body of the coil component according to the third exemplary embodiment in the present disclosure.

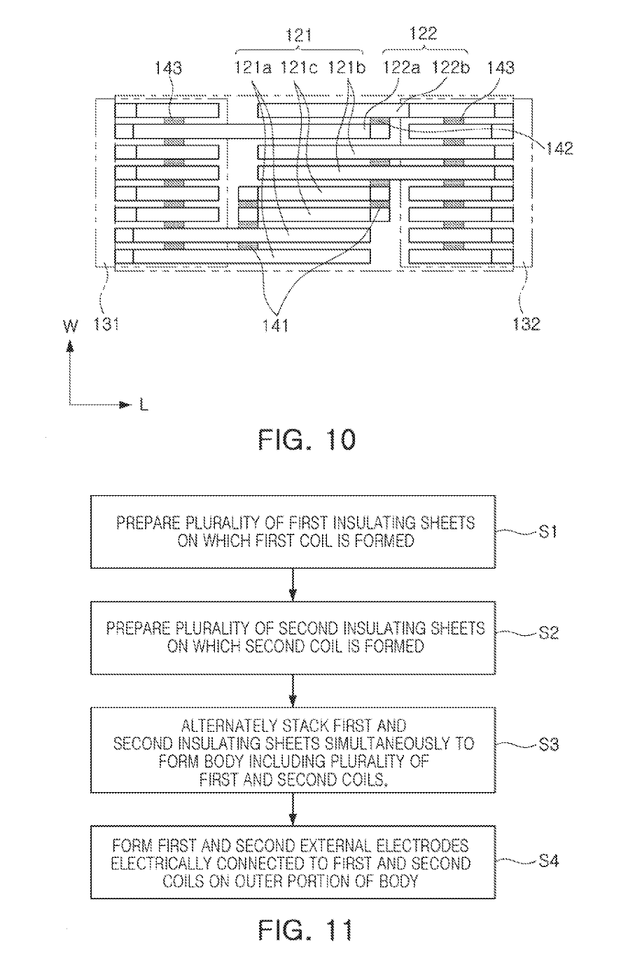

FIG. 10 is a plan view of a coil of the coil component of FIG. 8.

Referring to FIGS. 8 through 10, the coil component according to the third exemplary embodiment in the present disclosure may have a structure similar to that of the coil component according to the first exemplary embodiment, but may differ in that a connection pattern 121c is further included in the coil component and the second coil 122 is formed of third and fourth coil patterns 122a and 122b.

More specifically, according to the third exemplary embodiment in the present disclosure, a first coil 121 may include first and second coil patterns 121a and 121b connected to each other by a first via 141 in a body 110 and exposed to respective end surfaces of the body 110, and a connection pattern 121c disposed between the first and second coil patterns 121a and 121b. The second coil 122 may include the third and fourth coil patterns 122a and 122b connected to each other by a second via 142 in the body 110 and exposed to respective end surfaces of the body 110.

Because the first coil 121 includes the first and second coil patterns 121a and 121b and the connection pattern 121c between the first and second coil patterns 121a and 121b, the first coil 121 may have a coil structure with 2.5 turns.

According to the third exemplary embodiment in the present disclosure, the number of turns of the first coil 121 may be 2.5 turns and the number of turns of the second coil 122 may be 1.5 turns.

Because the second coil 122 has 1.5 turns, the difference between turns of the first and second coils may be 1.0 turns.

The coil component according to the third exemplary embodiment in the present disclosure may have an inductance between an inductance of the first coil 121 with 2.5 turns and an inductance of the second coil 122 with 1.5 turns.

More specifically, the coil component according to the third exemplary embodiment in the present disclosure may achieve an inductance within a range between the minimum inductance of a first coil 121 with 2.5 turns and the maximum inductance of a second coil 122 with 1.5 turns.

The third coil pattern 122a may include a third lead portion 122a′ exposed to one surface of the body 110 in the length direction. The fourth coil pattern 122b may include a fourth lead portion 122b′ exposed to the opposing surface of the body 110 in the length direction.

As in the first exemplary embodiment in the present disclosure, external electrodes 131 and 132 may be disposed on both end portions of the body 110. The first coil 121 may have lead portions 121a′ and 121b′ exposed to respective end portions of the body 110. The second coil 122 may have lead portions 122a′ and 122b′ exposed respective end portions of the body 110. The first and second coils 122 and 122 may be connected to each other by the external electrodes 131 and 132.

The first and second coils 121 and 122 may be connected to each other by a third via 143 connecting the lead portions 121a′, 121b′, 122a′ and 122b′.

More specifically, the first coil 121 may be formed of the first coil pattern 121a having the first lead portion 121a′ exposed to one end portion of the body 110 in the length direction, and the second coil pattern 121b having the second lead portion 121b′ exposed to the opposing end portion of the body 110 in the length direction.

The second coil 122 may be formed of the third coil pattern 122a having the third lead portion 122a′ exposed to one end portion of the body 110 in the length direction, and the fourth coil pattern 122b having a fourth lead portion 122b′ exposed to the opposing end portion of the body 110 in the length direction.

The lead portions 121a′, 121b′, 122a′ and 122b′ may be connected to each other by the third via 143. The first and second coils 121 and 122 may otherwise be insulated from each other in the body 110.

As described above, since the first and second coils 121 and 122 are insulated from each other in the body 110, the first and second coils 121 and 122 may be connected to each other in parallel.

A coil component according to another exemplary embodiment in the present disclosure may include a body 110 including a plurality of coils with insulating layers 111 interposed therebetween. The plurality of coils may include first and second coils 121 and 122 having a different number of turns. The overall inductance of the plurality of coils may be within a range between an inductance of the first coils and an inductance of the second coils.

As described above, in the coil component according to another exemplary embodiment in the present disclosure, different coil structures, that is, coils with different numbers of turns, may be combined and connected to each other in parallel in a single coil component, such that an inductance value in a middle range of inductance values of respective coils having the same number of turns may be implemented.

Hereinafter, a method of manufacturing a coil component according to the present disclosure will be described.

FIG. 11 is a process flowchart illustrating a method of manufacturing a coil component according to an exemplary embodiment in the present disclosure.

Referring to FIG. 11, the method of manufacturing a coil component according to an exemplary embodiment in the present disclosure may include preparing a plurality of first insulating sheets on which a first coil is formed (S1) and preparing a plurality of second insulating sheets on which a second coil is formed (S2). The plurality of first insulating sheets may be stacked on the plurality of second insulating sheets to form a body including a plurality of first and second coils (S3). The number of turns of the first and second coils are different from each other, and the first and second coils may be connected to each other in parallel.

The plurality of insulating sheets may be prepared first.

The magnetic material used to manufacture the insulating sheet is not particularly limited and may be, for example, ferrite powder known in the art such as Mn—Zn based ferrite powder, Ni—Zn based ferrite powder, Ni—Zn—Cu based ferrite powder, Mn—Mg based ferrite powder, Ba based ferrite powder, Li based ferrite powder, or the like.

The plurality of insulating sheets may be prepared by applying slurry formed by mixing the magnetic material and an organic material onto a carrier film and drying the applied slurry.

A plurality of first insulating sheets on which first and second coil patterns and a via are formed may be prepared, and a plurality of second insulating sheets on which the second coil is formed may be prepared.

The first and second coil patterns and the second coil may be formed in a thickness direction of the insulating sheet. The via may be formed by forming a through hole using a mechanical drill, a laser drill, or the like, and then filling the through hole with a conductive material by plating.

The first and second coil patterns and the second coil may be formed by applying a conductive paste containing a conductive metal on an insulating sheet using a printing method, or the like.

The printing method for the conductive paste may be a screen printing method, a gravure printing method, or the like, but is not limited thereto.

The conductive metal is not particularly limited as long as the metal has excellent electric conductivity. The conductive metal may be, for example, silver (Ag), palladium (Pd), aluminum (Al), nickel (Ni), titanium (Ti), gold (Au), copper (Cu), platinum (Pt), or the like, may be used alone, or a mixture thereof.

The via 45 may contain a conductive material such as copper (Cu), aluminum (Al), silver (Ag), tin (Sn), gold (Au), nickel (Ni), lead (Pb), an alloy thereof, or the like.

As described below, the first and second coil patterns may form the first coil in the stacking of the plurality of insulating sheets to form the body, and include first and second lead portions.

The body including the plurality of coils may be formed by alternately stacking the first and second insulating sheets simultaneously.

The body including the coil of which first and second lead portions are exposed to a lower surface of the body and surfaces of the body perpendicular to a stacking surface thereof may be formed by stacking the first and second insulating sheets.

The via may be formed between the first and second coil patterns, and the first and second coil patterns formed on the insulating layers, respectively, may be electrically connected to each other through the via, thereby forming a single coil.

The first and second lead portions of the first and second coil patterns forming the single coil may be exposed to the lower surface of the body and the surfaces of the body perpendicular to the stacking surface thereof.

The first and second coil patterns may be formed in a direction perpendicular to a board mounting surface of the body.

The first and second coil patterns may form the first coil. The first and second coils may have a different number of turns from each other may be connected to each other in parallel.

First and second external electrodes may be formed on the lower surface of the body and the surfaces of the body perpendicular to the stacking surface of the body (S4), to be connected to the lead portions of the first and second coils, respectively.

The first and second external electrodes may be formed using a conductive paste containing a metal having excellent electric conductivity. The conductive paste may contain, for example, one of nickel (Ni) and tin (Sn), an alloy thereof, or the like.

A description of features overlapping those of the multilayer electronic component according to the exemplary embodiment in the present disclosure described above is omitted.

As set forth above, according to exemplary embodiments in the present disclosure, the significantly low inductance to be desired may be implemented by combining different coil structures in parallel in the single coil component.

More specifically, an inductor having a significantly low inductance may be implemented by a composite structure in which turns of the first and second coils are different from each other and the first and second coils are connected to each other in parallel.

In the single coil component, coils with different numbers of turns may be combined and connected to each other in parallel, such that an inductance within a range of inductance values of respective coils having the same number of turns may be implemented.

While exemplary embodiments have been shown and described above, it will be apparent to those skilled in the art that modifications and variations could be made without departing from the scope of the present invention as defined by the appended claims.

What is claimed is:

1. A coil component comprising:
a body including a first coil with a first number of turns and a second coil with a second number of turns,
wherein the first number of turns is different from the second number of turns, and
wherein the first and second coils are connected to each other in parallel.

2. The coil component of claim 1, wherein the first number of turns differs from the second number of turns by a natural number.

3. The coil component of claim 1, wherein the first number of turns is 0.5+(M-1), the second number of turns is 0.5+N, M and N are both natural numbers, and M and N are the same as each other.

4. The coil component of claim 1, wherein the first number of turns is 0.5+(M-1), the second number of turns is 0.5+N, M and N are both natural numbers, and M and N are different from each other.

5. The coil component of claim 1, wherein the first coil is formed of first and second coil patterns connected to each other through a first via in the body and exposed to respective end surfaces of the body.

6. The coil component of claim 1,
wherein the first coil includes first and second coil patterns exposed to respective end surfaces of the body, and a connection pattern connected between the first and second coil patterns,
wherein the first coil pattern and the connection pattern are connected through a first via, and
wherein the second coil pattern and the connection pattern are connected through a second via.

7. The coil component of claim 6, wherein the second coil is formed of third and fourth coil patterns connected to each other through a second via in the body and exposed to the respective end surfaces of the body.

8. The coil component of claim 1, wherein external electrodes are on respective end portions of the body, and
the first and second coils each have lead portions exposed to respective end portions of the body, and are connected to each other by the external electrodes.

9. The coil component of claim 1, wherein the first and second coils each have lead portions exposed to respective end portions of the body and are connected to each other by vias connecting lead portions to each other.

10. The coil component of claim 1, wherein each of the first and second coils includes a plurality of coil patterns, and among the plurality of coil patterns, coil patterns having the same shape are in parallel with each other.

11. The coil component of claim 1, wherein the first and second coils have different line widths from each other.

12. The coil component of claim 1, wherein the first and second coils have different thicknesses from each other.

13. A coil component comprising:
a body including a first coil with a first number of turns and a second coil with a second number of turns,
wherein the first number of turns is different from the second number of turns, and
an overall inductance of the first and second coils is within a range between a first inductance of the first coils and a second inductance of the second coils.

14. A method of manufacturing a coil component, the method comprising:
preparing a plurality of first insulating sheets on which first coil patterns of a first coil are respectively formed;
preparing a plurality of second insulating sheets on which second coil patterns of a second coil are respectively formed; and
stacking the first and second insulating sheets simultaneously to form a body including a plurality of first and second coils,
wherein the first coil has a first number of turns and the second coil has a second number of turns different from the first number of turns, and
wherein the first and second coils are connected to each other in parallel.

15. The method of claim 14, wherein the first number of turns differs from the second number of turns by a natural number.

16. A coil component comprising:
a body comprising:
a first coil pattern of a first coil, including a first lead portion exposed at a first end surface of the body;
a second coil pattern of the first coil, including a second lead portion exposed at a second end surface of the body opposing the first end surface; and
one or more connection patterns of the first coil electrically connected to the first coil pattern by a first via and electrically connected to the second coil pattern by a second via;
a third coil pattern of a second coil, including a third lead portion exposed at the first end surface and a fourth lead portion exposed at the second end surface;
a third via electrically connecting the first lead portion to the third lead portion; and
a fourth via electrically connecting the second lead portion to the fourth lead portion.

17. The coil component of claim 16, further comprising:
a first external electrode on the first end surface of the body and extending to a mounting surface of the body that connects the first end surface to the second end surface;
a second external electrode on the second end surface of the body and extending to the mounting surface,
wherein the first, second, third, and fourth lead portions each have an L shape and are each exposed to the mounting surface of the body, and
wherein the first and third lead portions are connected to the first external electrode, and the second and fourth lead portions are connected to the second external electrode.

18. The coil component of claim 16, wherein the first and second coils have different line widths from each other.

19. The coil component of claim 16, wherein the first and second coils have different thicknesses from each other.

20. A coil component comprising:
a body, comprising:
a first coil pattern of a first coil, including a first lead portion exposed at a first end surface of the body;
a second coil pattern of the first coil, including a second lead portion exposed at a second end surface of the body opposing the first end surface; and
one or more first connection patterns of the first coil electrically connected to the first coil pattern by a first via and electrically connected to the second coil pattern by a second via;
a third coil pattern of a second coil, including a third lead portion exposed at the first end surface;
a fourth coil pattern of the second coil, including a fourth lead portion exposed at the second end surface;
a third via electrically connecting the first lead portion to the third lead portion; and
a fourth via electrically connecting the second lead portion to the fourth lead portion,
wherein the first coil has a first number of turns, the second coil has a second number of turns, and the first number of turns is different from the second number of turns.

21. The coil component of 20, further comprising:
one or more second connection patterns of the second coil electrically connected to the third coil pattern by a fifth via and electrically connected to the fourth coil pattern by a sixth via.

22. The coil component of claim 20, further comprising:
a first external electrode on the first end surface of the body and extending to a mounting surface of the body that connects the first end surface to the second end surface;
a second external electrode on the second end surface of the body and extending to the mounting surface,
wherein the first, second, third, and fourth lead portions each have an L shape and are each exposed to the mounting surface of the body, and
wherein the first and third lead portions are connected to the first external electrode, and the second and fourth lead portions are connected to the second external electrode.

23. The coil component of claim 20, wherein the first and second coils have different line widths from each other or different thicknesses from each other.

24. A coil component comprising:
a body including a first coil and a second coil connected to each other in parallel,
wherein a first inductance of the first coil is different from a second inductance of the second coil.
